(19) United States
(12) Patent Application Publication
(10) Pub. No.: US 2019/0298057 A1
(43) Pub. Date: Oct. 3, 2019

(54) COMBINED BRACKET

(71) Applicant: Futurepath Technology (Shenzhen) Co., Ltd., Shenzhen (CN)

(72) Inventors: Jun XIAO, Shenzhen (CN); Xiaobo WANG, Shenzhen (CN); Haizhen LI, Shenzhen (CN); Jianming LU, Shenzhen (CN); Mingshui RUAN, Shenzhen (CN)

(73) Assignee: Futurepath Technology (Shenzhen) Co., Ltd., Shenzhen (CN)

(21) Appl. No.: 15/990,697

(22) Filed: May 28, 2018

(30) Foreign Application Priority Data
Mar. 28, 2018 (CN) 201810264910.9

(51) Int. Cl. A47B 23/00; F16B 5/00

(52) U.S. Cl. CPC A47B 23/00; F16B 5/00

(57) ABSTRACT

A combined bracket includes a first bracket and a second bracket, the first bracket and the second bracket are detachably connected. The first bracket includes a first pin and a second pin respectively formed at two ends of the first bracket, and the length of the first pin is larger or smaller than the length of the second pin, making the first pin and the second pin asymmetric. The second bracket is provided with a slot. One of the first pin and the second pin are inserted in the slot and cooperate with one end of the second bracket to form a platform for supporting the mobile device. The other one of the first pin and the second pin and the other end of the second bracket form supporting legs of the combined bracket.

### CROSS REFERENCE TO RELATED APPLICATIONS

This non-provisional patent application claims priority under 35 U.S.C. § 119(a) from Patent Application No. 201810264910.9 filed in The People's Republic of China on Mar. 28, 2018.

### TECHNICAL FIELD

The present invention relates to the field of support brackets, and in particular to combined brackets for supporting mobile electric apparatus.

### BACKGROUND

Mobile devices have increasingly become indispensable parts of people. Some users use mobile devices to watch movies while resting or even cooking. When in use, the mobile devices are directly placed on a desktop horizontally, causing users constantly bend waist to see the movie, which makes users feel uncomfortable in body. Now various kinds of mobile device brackets appear, but these mobile device brackets are costly to manufacture and not suitable for carrying.

### SUMMARY

Thus, there is a desire for an improved combined bracket.

The present invention provides a combined bracket configured to comprise a first bracket and a second bracket, the first bracket and the second bracket are detachably connected. The first bracket comprises a first pin and a second pin respectively set in two ends, the first pin having a length and the second pin having a length, the length of the first pin is larger or smaller than the length of the second pin. The second bracket is provided with a slot. One of the first pin and the second pin may be inserted in the slot and cooperate with one end of the second bracket to form a platform for supporting a mobile device. The other one of the first pin and the second pin and the other end of the second bracket act as the supporting legs of the combined bracket.

Preferably, the first bracket has an “H” structure. The first bracket comprises a first middle support plate, two first pins and two second pins. Two first pins are disposed on one side of the first middle support plate, two second pins are disposed on the other side of the first middle support plate.

Preferably, the number of the slots is an even number greater than or equal to two, the slots symmetrically distributed at apposite sides of the second bracket.

Preferably, the number of the slots is an even number greater than or equal to four.

Preferably, the number of the slots is ten.

Preferably, the second bracket has a rectangular structure, and the second bracket has two first outer edges opposite to each other, and two second outer edges opposite to each other, the two second outer edges are connected between the two first outer edges, and ten slots are formed at the two first outer edges and symmetrically distributed with respect to the midlines of the second bracket in length direction.

Preferably, the distance from a midline of any one of the slot to one of the two second outer edges is greater or less than the distance from the other two second outer edges.

Preferably, the second bracket comprises a second middle support plate, a first end support plate and a second end support plate, the first end support plate is disposed at one end of the second middle support plate, the second end support plate is disposed at the other end of the second middle support plate. And the slots are formed on the second middle support plate.

Preferably, the first end support plate and the second end support plate are disposed along the length direction of the first outer edges of the second bracket, the length of the first end support plate in the length direction of the first outer edges is greater or less than the length of the second end support plate in the length direction of the first outer edges.

Preferably, the outer surface of the first bracket or/and the second bracket are provided with anti-slip pattern.

Preferably, the second bracket has a rectangular configuration which comprises a pair of first outer edges opposite to each other and a pair of second outer edges opposite to each other, the two second outer edges being connected between the first outer edges, a plurality of slots being formed at the first outer edges and symmetrically distributed with respect to the midline of the second bracket in length direction.

In the combined bracket according to an embodiment of the present invention, the length of the first pin is larger or smaller than the length of the second pin, thus making the first pin and the second pin asymmetric. One of the first pin or the second pin may be inserted into the slots of the second bracket and cooperate with one end of the second bracket to forms a platform for supporting a mobile device. The other one of the first pin and the second pin and the other end of the second bracket act as the supporting legs of the combined bracket, which makes the combined bracket has different splicing methods and tilt angle to meet different requirements. The first bracket and the second bracket are simple in structure, low in manufacturing cost, and easy to use in wide range. When not in use, the combined bracket can be carried conveniently after it is disassembled.

### BRIEF DESCRIPTION OF THE DRAWINGS

FIG. 1 is a schematic view of the combined bracket according to an embodiment of the present disclosure.

FIG. 2 is an exploded view of the combined bracket of FIG. 1.

FIG. 3 is a schematic view of the first bracket of FIG. 1.

FIG. 4 is a schematic view of the second bracket according to an alternative embodiment of the present disclosure.

Reference numerals of main components

| | |
|---|---|
| first bracket | 10 |
| first pin | 11 |
| second pin | 12 |
| first middle support plate | 13 |
| second bracket | 20 |
| slot | 21 |
| second middle support plate | 22 |
| first end support plate | 23 |
| second end support plate | 24 |
| first outer edge | 201 |
| second outer edge | 202 |

### DETAILED DESCRIPTION OF THE EMBODIMENTS

Below, embodiments of the present invention will be described in greater detail with reference to the drawings. It should be noted that the figures are illustrative rather than limiting. The figures are not drawn to scale, do not illustrate every aspect of the described embodiments, and do not limit the scope of the present disclosure.

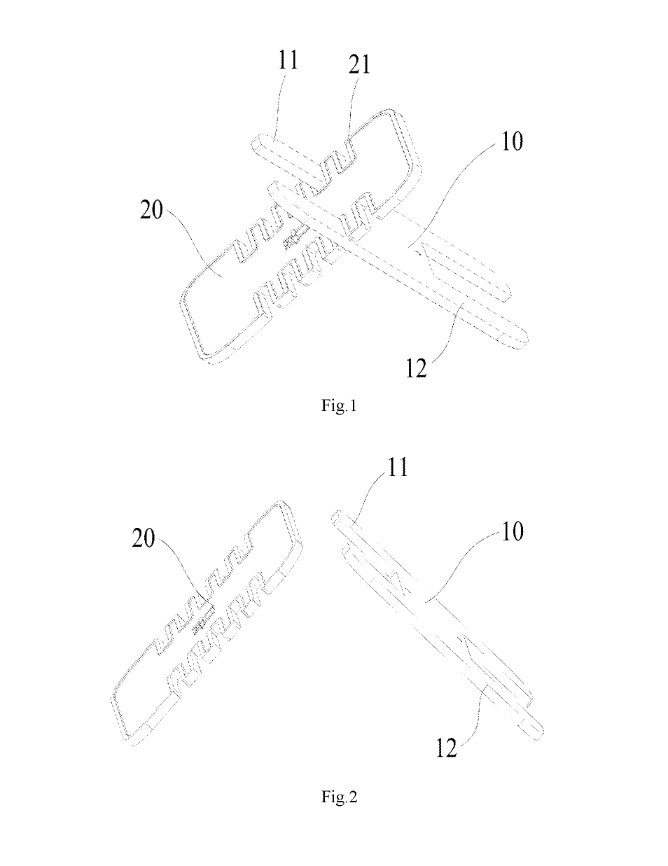

Referring to FIG. 1 to FIG. 4, an embodiment of the present invention provides a combined bracket, which is used for supporting mobile devices. The combined bracket comprises a first bracket 10 and a second bracket 20, the first bracket 10 and the second bracket 20 are detachably connected. The first bracket 10 has an elongated shape and comprises a first pin 11 and a second pin 12 respectively formed at two opposite ends thereof, and the length of the first pin 11 are larger or smaller than the length of the second pin 12, thus making the first pin 11 and the second pin 12 asymmetric. The second bracket 20 has an elongated shape and is provided with a plurality of slots 21 arranged in the elongated direction of the second bracket 20. The slots 21 are matched with the first pin 11 and the second pin 12. The first bracket 10 and the second bracket 20 are simple in structure, low in manufacturing cost, and easy to use in wide range.

In use, one of the first pin 11 and the second pin 12 is inserted into one of the slots 21 and forms a platform with one end of the second bracket 20 for supporting a mobile device. The other one of the first pin 11 and the second pin 12 forms a supporting leg of the combined bracket and the other end of the second bracket 20 forms another supporting leg of the combined bracket. One of the first pin 11 and second pin 12 may be inserted into different slot 21 which makes the combined bracket has different splicing methods and tilt angle to meet different requirements. When not in use, the combined bracket can be conveniently carried after it is disassembled.

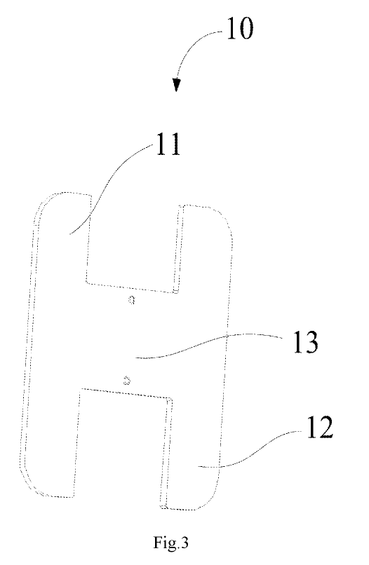

In one embodiment, referring to the FIG. 3, the first bracket 10 has an “H” configuration. The first bracket 10 comprises a first middle support plate 13, two first pins 11 and two second pins 12. The two first pins 11 are connected to one side of the first middle support plate 13, the two second pins 12 are connected to the other side of the first middle support plate 13, and the two first pins 11 and the two second pins 12 are opposite to each other. The two first pins 11 or the two second pins 12 are inserted into the slot 21 of the second bracket 20 and form a bracket with an angle formed between the first bracket and the second bracket. In this way, there are at least two adjustable angles for the combined bracket, so that the angle can be adjusted according to the use situation. Specifically, the length direction of the two first pins 11 and the length direction of the two second pins 12 are defined as the length direction of the first bracket 10, the difference between the length of the two first pins 11 and the length of the two second pins 12 in the length direction of the first bracket 10 is about half of length of the first middle support plate 13 in the length direction of the first bracket 10.

As a preferred embodiment, the number of the slots 21 is an even number greater than or equal to two. The slots 21 are symmetrically distributed on both sides of the second bracket 20, so that the combined bracket has at least four adjustable angles to choose from.

As a preferred embodiment, the number of the slots 21 is an even number greater than or equal to four. The slots 21 are symmetrically distributed on both sides of the second bracket 20, so that the combined bracket has at least eight adjustable angles to choose from.

In an embodiment, the number of the slots 21 are ten, the combined bracket has at least twenty adjustable angles to choose from.

In an embodiment, the second bracket 20 has a rectangular structure, and the second bracket 20 has two first outer edges 201 positioned opposite to each other, and two second outer edges 202 positioned opposite to each other, the two second outer edges 202 are connected between ends of the two first outer edges 201, Preferably, the first outer edges 201 extend along the length direction of the second bracket 20 and the second outer edges 201 extend along the width direction of the second bracket 20 and the slots 21 are respectively formed at the first outer edges 201. ten slots 21 are symmetrically distributed with respect to the midlines of the second bracket 20 in the length direction so as to correspond to the positions of the two first pins 11 and the two second pins 12.

As a preferred embodiment, the distance from the midline of the opening of any one of the slots 21 to one of the two second outer edges 202 is greater or less than the distance to the other of the two second outer edges 202, so that the combined bracket has at twenty adjustable angles. To reduce the rigidity of the combined bracket, the width of the opening of the slots 21 is larger than the thickness of the first bracket 10.

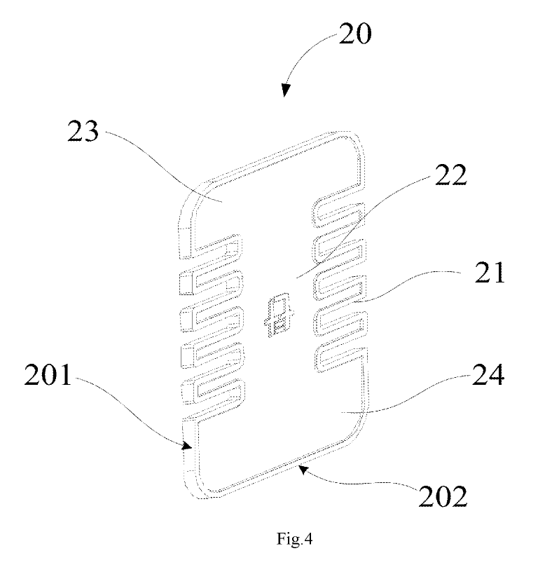

Refer to FIG. 4, the second bracket 20 comprises a second middle support plate 22, a first end support plate 23 and a second end support plate 24, and the first end support plate 23 is disposed at one end of the second middle support plate 22, the second end support plate 24 is disposed at the other end of the second middle support plate 22. The slots 21 are formed at the second middle support plate 22, when the first pin 11 or the second pin 12 is inserted into the slots 21, the first middle support plate 13 abuts against the second middle support plate 22, and thus the above platform is formed on the combined bracket.

As a preferred embodiment, the first end support plate 23 and the second end support plate 24 are disposed along the length direction of the first outer edges 201 of the second bracket 20, the length of the first end support plate 23 in the length direction of the first outer edges 201 is greater or less than the length of the second end support plate 24 in the length direction of the first outer edges 201, so that the upper and lower sides of the second bracket 20 can be distinguished quickly.

In one embodiment, the outer surface of the first bracket 10 or/and the second bracket 20 are provided with non-slip pattern, to prevent the mobile device slipping from the combined bracket.

In summary, the length of the first pin 11 is larger or smaller than the length of the second pin 12, thus, making the first pin 11 and the second pin 12 asymmetric. One of the first pin 11 or the second pin 12 is inserted into the slot 21 of the second bracket 20 and forms a platform with one end of the second bracket for supporting a mobile device, the other one of the first pin 11 and the second pin 12 acts as the supporting legs of the combined bracket together with the other end of the second bracket 20, which makes the combined bracket has different splicing methods and tilt angle to meet different requirements. The first bracket 10 and the second bracket 20 are simple in structure, low in manufacturing cost, and easy to use in wide range. When not in use, the combined bracket can be carried conveniently after it is disassembled.

It should be noted that the combined bracket is not limited to the placement of the mobile device but albums, stationery and accessories.

Therefore, the technical solutions of embodiments of the present invention have been clearly and completely described above. Apparently, the described embodiments are merely part of, rather than all of, the embodiments of the present invention. A person skilled in the art may make various combineds of technical features in the various embodiments to meet practical needs. Based on the described embodiments of the present invention, any other embodiment obtained by a person skilled in the art without paying creative efforts shall also fall within the scope of the present invention.

1. A combined bracket, comprising:
a first bracket comprising a first pin and a second pin respectively formed at two ends of the first bracket, wherein a length of the first pin is larger or smaller than a length of the second pin; and
a second bracket provided with a slot;
wherein one of the first pin and the second pin is inserted in the slot and cooperate with one end of the second bracket to form a platform for supporting a mobile device, and the other one of the first pin and the second pin and an other end of the second bracket form supporting legs of the combined bracket,
wherein the first bracket has an “H” configuration, the first bracket comprises a first middle support plate, two first pins and two second pins, the two first pins are disposed on one side of the first middle support plate, the two second pins are disposed on an other side of the first middle support plate.

2. (canceled)

3. The combined bracket of claim 1, wherein a number of the slots is an even number greater than or equal to two, the slots are symmetrically distributed at opposite sides of the second bracket.

4. The combined bracket of claim 3, wherein the number of the slots is an even number greater than or equal to four.

5. The combined bracket of claim 4, wherein the number of the slots is ten.

6. The combined bracket of claim 5, wherein the second bracket has a rectangular structure, the second bracket has two first outer edges provided opposite to each other, and two second outer edges provided opposite to each other, the two second outer edges are connected between the two first outer edges, and the ten slots are formed at the two first outer edges and symmetrically distributed with respect to a midline of the second bracket.

7. The combined bracket of claim 6, wherein a distance from a midline of one of the slots to one outer edge of the two second outer edges is greater or less than a distance from the midline of the one of the slots to the other outer edge of the two second outer edges.

8. The combined bracket of claim 5, wherein the second bracket comprises a second middle support plate, a first end support plate and a second end support plate, the first end support plate is disposed at one end of the second middle support plate, the second end support plate is disposed at an other end of the second middle support plate, and the slots are formed at the second middle support plate.

9. The combined bracket of claim 8, wherein the first end support plate and the second end support plate are disposed along a length direction of the first outer edges of the second bracket, the length of the first end support plate in the length direction of the first outer edges is greater or less than the length of the second end support plate in the length direction of the first outer edges.

10. The combined bracket of claim 1, wherein an outer surface of the first bracket and an outer surface of the second bracket are provided with anti-slip patterns.

11. The combined bracket of claim 1, wherein the second bracket has a rectangular configuration which comprises a pair of first outer edges provided opposite to each other and a pair of second outer edges provided opposite to each other, the two second outer edges being connected between the first outer edges, a plurality of slots being formed at the first outer edges and symmetrically distributed with respect to a midline of the second bracket.

12. The combined bracket of claim 1, wherein an outer surface of the first bracket or an outer surface of the second bracket is provided with anti-slip patterns.
